(19) United States
(12) Patent Application Publication
(10) Pub. No.: US 2014/0325490 A1
(43) Pub. Date: Oct. 30, 2014

(54) Classifying Source Code Using an Expertise Model

(71) Applicant: HEWLETT-PACKARD DEVELOPMENT COMPANY, L.P., (US)

(72) Inventors: Guy Wiener, Haifa (IL); Omer Barkol, Haifa (IL)

(73) Assignee: HEWLETT-PACKARD DEVELOPMENT COMPANY, L.P., Houston, TX (US)

(21) Appl. No.: 13/870,295

(22) Filed: Apr. 25, 2013

(51) Int. Cl. G06F 9/44

(52) U.S. Cl. CPC G06F 8/70
USPC 717/131

(57) ABSTRACT

A technique to classify source code based on skill level. Features may be extracted from the source code. The source code may be classified based on the extracted features using an expertise model.

### BACKGROUND

It can be challenging to manage the software development process. One factor that can influence the quality of a software project is the skill of the developer(s) who author the source code for the project. Sometimes one may be aware of the skill level of the developers staffed on the project and may assess the quality and trustworthiness of source code based on that information. However, with large software projects, this may not always be the case, especially if temporary workers are involved. In addition, particular modules of source code may be associated with multiple authors of varying skill level. Furthermore, one may not be familiar with the author(s) of legacy source code, or the skill level of such authors may have changed over time.

Typical software quality metrics may look only at whether there are defects (i.e., errors) in the source code These metrics only penalize code that is actually defective and may not identify low quality source code that happens to have no defects. Other software quality metrics may rely on proxies such as code length. Such metrics may penalize a piece of source code because it solves a complex problem. The low score thus may derive from the intrinsic complexity of the problem, rather than from poor design or lack of skill of the developer. Accordingly, it can be difficult to accurately evaluate the quality and trustworthiness of source code. It can also be difficult to assess the skill level of a developer.

### BRIEF DESCRIPTION OF DRAWINGS

The following detailed description refers to the drawings, wherein:

FIG. 1(a) illustrates a method of classifying source code using an expertise model, according to an example.

FIG. 1(b) illustrates a method of extracting programming features, according to an example.

FIG. 2 illustrates a method of classifying multiple source code modules using an expertise model, according to an example.

FIGS. 3(a)-3(c) illustrate histograms of programming feature usage corresponding to an expertise model, according to an example.

FIG. 4 illustrates a system for classifying source code using an expertise model, according to an example.

FIG. 5 illustrates a computer-readable medium for classifying source code using an expertise model, according to an example.

### DETAILED DESCRIPTION

According to an example, a technique may evaluate source code based on an expertise model. The expertise model may be used to estimate the skill level of the author(s) of the source code. For instance, the technique may include extracting features from source code written in a programming language. The technique may further include classifying the source code by comparing the extracted features to an expertise model. The expertise model may model a usage frequency of programming features of the programming language according to a plurality of skill levels. For example, the skill levels may include novice, normal, and expert. The programming features may include lexical features, syntactic features, and semantic features. The expertise model may further model other metrics relating to usage of the programming features, such as an average length of functions by skill level, an average number of arguments per function by skill level, and combinations thereof. A risk level may be assigned to the source code based on the classification. Additionally, an estimated skill level may be assigned to an author of the source code based on the classification.

As a result, the quality and trustworthiness of software modules may be estimated using the disclosed techniques. This information may be used to manage a software project and/or to decide whether to use a particular legacy software module. Additionally, the skill levels of developers may be estimated using the disclosed techniques. This information may be used to estimate the quality and trustworthiness of other software modules authored by a particular developer, as well as to make personnel decisions, find members for a development team, or assess training needs. Additional examples, advantages, features, modifications and the like are described below with reference to the drawings.

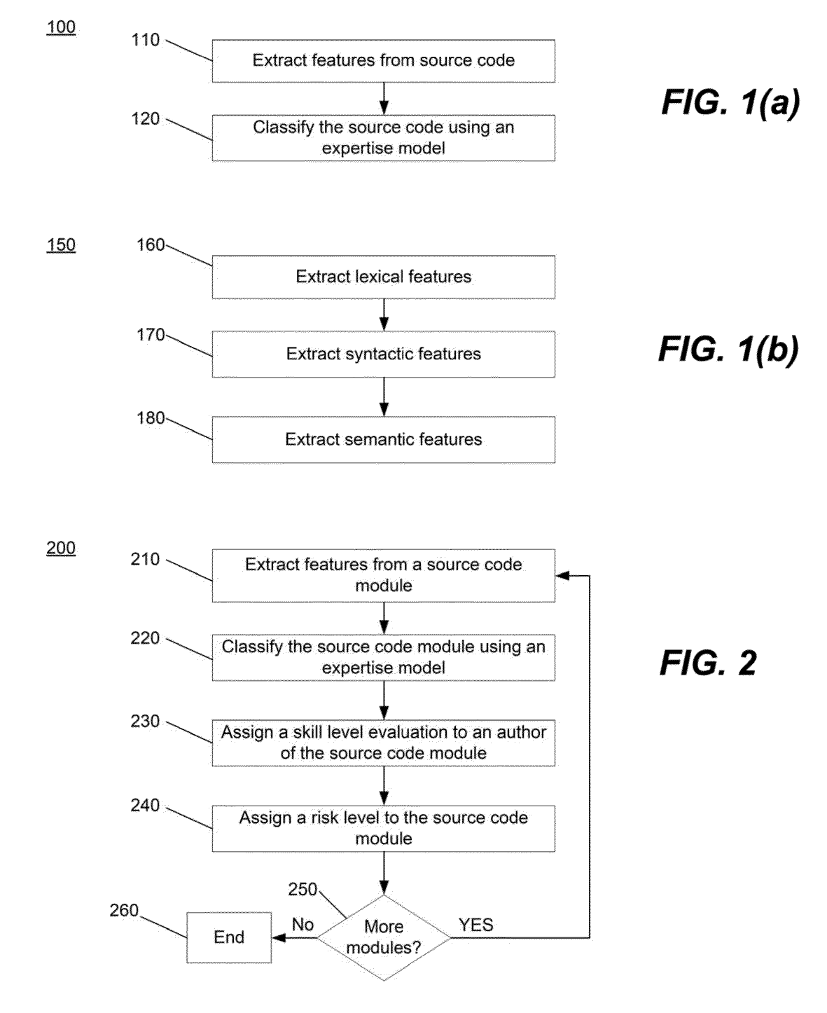

FIG. 1(a) illustrates a method of classifying source code using an expertise model, according to an example. Method 100 may be performed by a computing device, system, or computer, such as computing system 400 or computer 500. Computer-readable instructions for implementing method 100 may be stored on a computer readable storage medium. These instructions as stored on the medium are referred to herein as “modules” and may be executed by a computer,

Method 100 may begin at 110, where features may be extracted from source code. The source code may be written in any of various programming languages, such as C, C++, C#, Java, and the like. The source code may be stored in a source code repository. The repository may be part of a software development platform. The platform may be a single or multiple software applications that facilitate the development and management of software. For example, the platform may include a source code management program to manage the code base stored in the source code repository, track changes to the code base, and track the authors of the source code and any changes to the source code.

The source code from which features are extracted may be a module of source code, such as an entire program, a class, a method or the like. The source code may be associated with one or more authors. An author may also be referred to as a developer, a software engineer, or a programmer.

Features may be extracted from the source code according to various techniques. “Feature” is used herein according to the understanding of the term in a machine learning context. In particular, the features extracted from the source code are used to enable classification of the source code by a classifier. An extracted feature is thus a measurement of a particular feature of the source cod As will be described more fully below with respect to block 120, the extracted features are measurements of the presence/usage within the source code of particular programming features. The particular programming features are features associated with the programming language of the source code that have been determined to be indicative of a skill level of an author of the source code. The extracted features may be lexical, syntactic, and semantic features available in the programming language.

At 120, the source code may be classified using an expertise model. For example, the source code may be classified with a classifier by comparing the extracted features to an expertise model associated with the classifier. The expertise model may model a usage frequency of programming features of the programming language according to a plurality of skill levels.

The programming features modeled by the expertise model may be lexical, syntactic, and semantic features of the programming language. Lexical features may be derived from a lexicon (i.e., vocabulary) associated with the programming language. Specifically, a lexicon may be the set of words available for use in a given programming language, including keywords, reserved words, built-in functions and tokens allowed in symbol names. The lexicon for one programming language may be different from the lexicon for another programming language. Furthermore, when generating an expertise model, a simplified lexicon may be used in place of a full lexicon of the programming language. Syntactic features of the programming language include features derived from the syntax of the programming language, such as statements, expressions, and structural elements (e.g., classes, methods). Semantic features of the programming language include programming features related to relationships between lexical and syntactic features of the programming language, such as overriding, polymorphism, and ambivalent methods (i.e., methods that require compilation or execution to be resolved). A classification algorithm and cross validation may be used to assign a weight to the various programming features for each of the skill levels.

In some examples, other metrics relating to usage of the programming features may be derived. For example, various measurements relating to how certain programming features are used may be indicative of expertise. For instance, example metrics may be an average length of a function and an average number of function arguments. As with the programming features described above, a classification algorithm and cross validation may be used to assign a weight to such metrics for each of the skill levels.

FIG. 1(b) illustrates a method of extracting programming features, according to an example. Method 150 may be performed by a computing device, system, or computer, such as computing system 400 or computer 500. Computer readable instructions for implementing method 150 may be stored on a computer readable storage medium. These instructions as stored on the medium are referred to herein as “modules” and may be executed by a computer,

Method 150 may begin at 160, where lexical features of the source code may be extracted. The lexical features may be extracted based on a lexicon of the programming language. At 170, syntactic features of the source code may be extracted. The syntactic features may be extracted using a parser. As an example, for the Java programming language, Java Parser may be used to extract syntactic features. At 180, semantic features of the source code may be extracted. The semantic features may be extracted using a static program analysis tool to determine the relationships between the lexical and syntactic features.

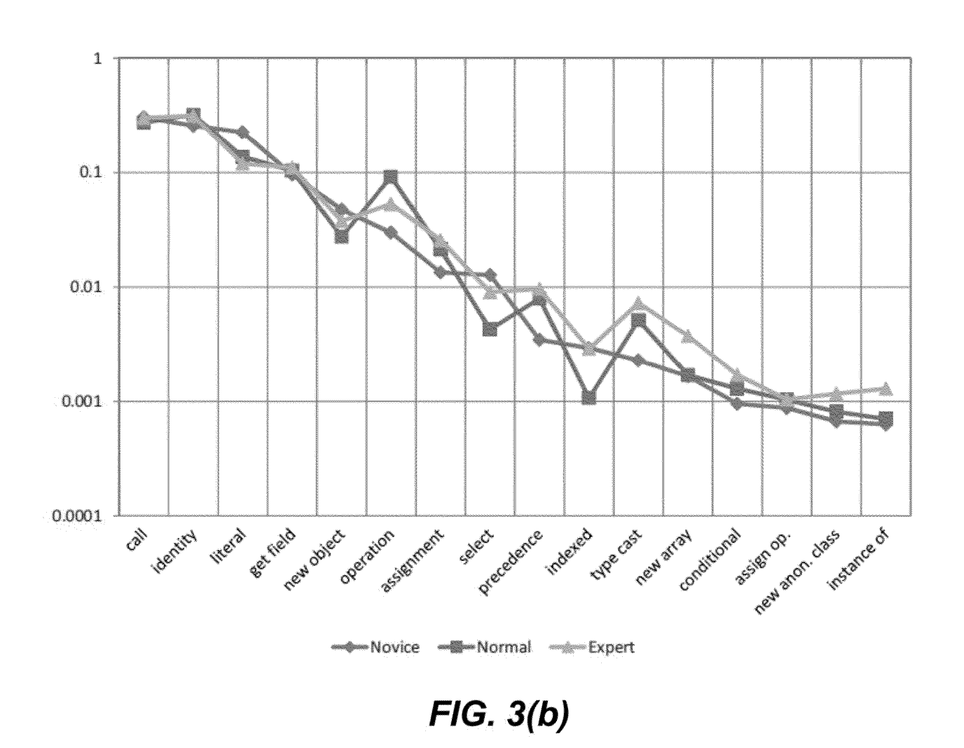

Turning to FIGS. 3(a)-3(c), histograms corresponding to an expertise model for the Java programming language are shown. The histograms depict the usage frequency of programming features according to three skill levels—novice, normal, and expert. These histograms correspond to an expertise model developed based on a labeled case set. Within the case set, the expertise of the developers of source code modules was determined based on an analysis of LinkedIn® profiles of the developers. Labels may be determined in other ways as well, such as through resumes, other profile information, or observation (whether in an active learning context, which may involve review of code, or simply due to personal familiarity with the developer). Although any of various classification algorithms may be used to develop the expertise model, here a K-Nearest-Neighbors algorithm was used. A classifier may include feature vectors corresponding to these histograms as the expertise model to model the three skill levels and classify source code.

FIGS. 3(a) and 3(b), which are plotted on a logarithmic scale, illustrate histograms for statements and expressions for the three levels of expertise. FIG. 3(a) shows that non-novice developers are more likely to use diverse control commands, such as throwing exceptions and writing switch-case statements. Additionally, experts are more likely to use assertions, do-while loops, and synchronized blocks.

FIG. 3(b) shows that non-novice developers tend to use more operators, parentheses, and assignments in an expression. This suggests that they feel more comfortable with complex expressions. FIG. 3(b) also shows that experts are more likely to use type tests and casting. Interestingly, it is believed that use of such is not necessarily evidence of good programming style, but rather is a residue of older versions of Java, and thus is indicative of the number of years of coding experience of the developer, which itself may correlate with a expertise (more years of experience generally leading to a higher level of expertise).

Another interesting observation is that experts tend to use a wider range of programming features. This was observed by sorting the programming features in the histograms according to their usage frequency by novices. As can be seen, the lines representing both normal and expert developers show a similar declining trend, but normal developers use more mid-range features while expert developers use more rarely-used features.

FIG. 3(c) shows the ratio of methods having a semantic feature, in this case a special object oriented programming semantic meaning, of all methods written by developers from each skill level. For each grouping, the novice level appears first, the normal level appears second, and the expert level appears third. The overriding grouping shows the ratio of methods overriding other methods from a base class. The polymorphic grouping shows the ratio of methods that have the same name as but different arguments from other methods. The ambivalent grouping shows the ratio of methods requiring compile-time or run-time resolution. As can be seen, expert developers use the semantic features of overriding and ambivalent methods more frequently than both normal and novice developers, reflecting a greater degree of comfort and facility with such features.

Although the expertise model reflected by the histograms shown in FIGS. 3(a)-3(c) was generated using a supervised learning process, an unsupervised learning process may be used to develop the expertise model. For example, given an unlabeled set of examples of source code, average values for a set of programming features may be determined. These average values may be used as a baseline, representing a normal developer. Additional skill levels may be derived from the examples based on deviations from the baseline. In an example, some of the observations expressed above (e.g., experts tend to use a wider array of features, novices tend to use a narrower array of features) may be used to interpret the deviations and associate them with a particular skill level and build a corresponding expertise model.

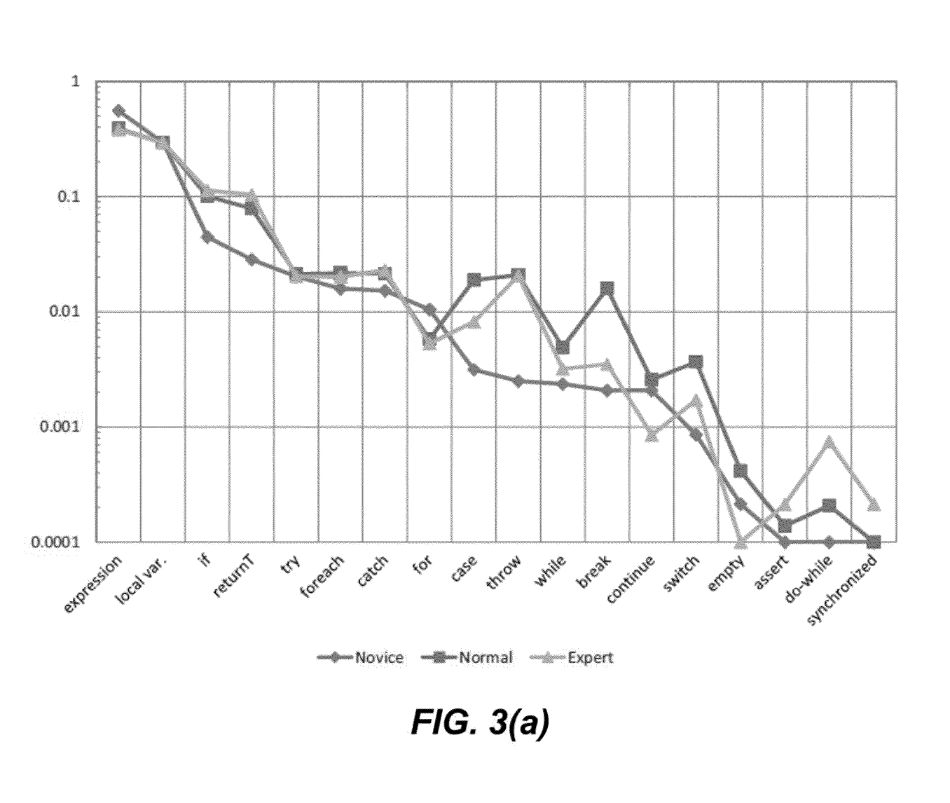

Turning now to FIG. 2, variations are shown that may be used to modify method 100. At the same time the description of method 100 applies to method 200. Method 200 may be performed by a computing device, system, or computer, such as computing system 400 or computer 500. Computer-readable instructions for implementing method 200 may be stored on a computer readable storage medium. These instructions as stored on the medium are referred to herein as “modules” and may be executed by a computer.

Method 200 may begin at 210, where features may be extracted from a source code module. At 220, the source code module may be classified into one of a plurality of skill levels using an expertise model. At 230, a skill level evaluation may be assigned to an author of the source code module based on the classification. The skill level evaluation may be used for various purposes, such as to estimate the quality and trustworthiness of other software modules authored by the developer, to make personnel decisions, to find members for a development team, or to assess training needs. Where multiple authors are associated with a source code module, the skill level evaluation may be assigned to all of the authors. At 240, a risk level, such as a developer expertise risk level, may be assigned to the source code module based on the classification. Referring to the example from FIGS. 3(a)-3(c), the novice skill level may be associated with a higher risk level than the normal skill level, and the normal skill level may be associated with a higher risk level than the expert skill level. At 250, it may be determined whether there are more modules to evaluate. If there are no more modules to evaluate, method 200 may end at 260. It there are more modules to evaluate, method 200 may proceed to 210 where another module may be evaluated.

Various modifications can be made to method 200. For example, block 230 may be omitted and a risk level may be assigned to a module based on the classification, as shown in block 240. In another example, block 230 may be an optional function that may be requested by a user supervising the execution of method 200. In yet another example, block 240 may be omitted, and method 200 may be run simply to estimate the level of expertise of one or more authors of the modules.

In an example, method 200 may be used to evaluate a code base to identify software modules having a higher risk of causing problems. For example, method 200 may be used to evaluate a large body of legacy code to determine whether each module should be maintained or discarded. The developer expertise risk level may be just one estimate or risk used to determine whether a given module should be deemed risky. For example, other software risk metrics may be used, such as code length and code age.

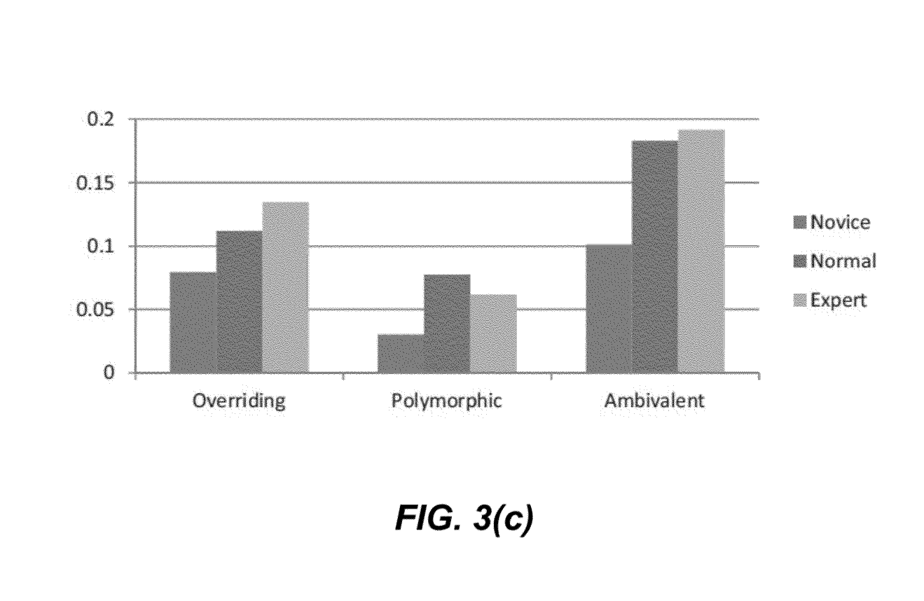

Turning now to FIG. 4, a system for classifying source code using an expertise model is illustrated, according to an example. Computing system 400 may include and/or be implemented by one or more computers. For example, the computers may be server computers, workstation computers, desktop computers, or the like. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at, least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM). Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, computing system 400 may include one or more machine-readable storage media separate from the one or more controllers, such as memory 410.

Computing system 400 may include memory 410, model generator 420, classifier 430, extractor 440, risk estimator 450, expertise estimator 460. Each of these components may be implemented by a single computer or multiple computers. The components may include software, one or more machine-readable media for storing the software, and one or more processors for executing the software. Software may be a computer program comprising machine-executable instructions.

In addition, users of computing system 400 may interact with computing system 400 through one or more other computers, which may or may not be considered part of computing system 400. As an example, a user may interact with system 400 via a computer application residing on system 400 or on another computer, such as a desktop computer, workstation computer, tablet computer, or the like. The computer application can include a user interface.

Computer system 400 may perform methods 100, 150, 200, and variations thereof, and components 420-460 may be configured to perform various portions of methods 100, 150, 200, and variations thereof. Additionally, the functionality implemented by components 420-460 may be part of a larger software platform, system, application, or the like. For example, these components may be part of a source code management platform.

In an example, memory 410 may be configured to store examples 412 and source code 414. Model generator 420 may be configured to generate an expertise estimation model based on the examples 412. Examples 412 may be labeled examples of source code written, by multiple developers each associated with one of a plurality of skill levels. The expertise estimation model may model a usage frequency of programming features. The programming features may be lexical features, syntactic features, and semantic features. Classifier 430 may be configured to classify the source code 414 into one of the plurality of skill levels using the expertise estimation model.

In an example, the source code 414 may be a module of source code for which a risk assessment is desired. Risk estimator 450 may be configured to estimate a risk level of the source code 414 based at least on the classified skill level and an additional software risk metric. In another example, the source code 414 may have been written by a developer for which a skill estimation is desired. Expertise estimator 460 may be configured to estimate a level of expertise of an author of the source code 414 based on the classified skill level. Other metrics (e.g., code length) may also be considered by the expertise estimator 460 when estimating the level of expertise of an author. In some cases, both a risk level of the source code 414 and expertise estimate of the author of the source code 414 may be desired.

In an example, extractor 440 may be configured to extract features from a module of source code, For example, extractor 440 may be configured to extract features from source code 414. Classifier 430 may be configured to classify source code 414 by comparing the extracted features to the expertise estimation model. Extractor 440 may include a parser and a static program analysis tool, The parser can be configured to extract syntactic features from the examples 412 and source code 414 The static program analysis tool may be configured to extract semantic features from the examples 412 and source code 414.

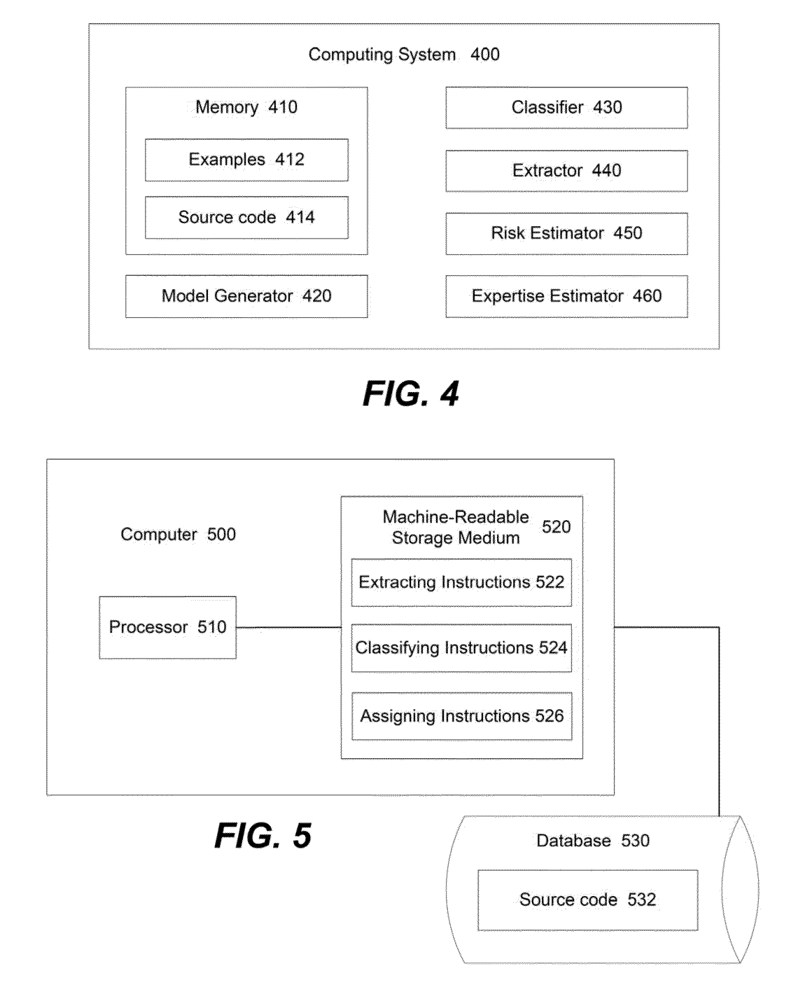

FIG. 5 illustrates a computer-readable medium for classifying source code using an expertise model, according to an example. Computer 500 may be any of a variety of computing devices or systems, such as described with respect to computing system 400.

Computer 500 may have access to database 530. Database 530 may include one or more computers, and may include one or more controllers and machine-readable storage mediums, as described herein. Computer 500 may be connected to database 530 via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

Processor 510 may be at least one central processing unit (CPU), at least one semiconductor-based microprocessor, other hardware devices or processing elements suitable to retrieve and execute instructions stored in machine-readable storage medium 520, or combinations thereof. Processor 510 can include single or multiple cores on a chip, multiple cores across multiple chips, multiple cores across multiple devices, or combinations thereof. Processor 510 may fetch, decode, and execute instructions 522-526 among others, to implement various processing. As an alternative or in addition to retrieving and executing instructions, processor 510 may include at least one integrated circuit (IC), other control logic, other electronic circuits, or combinations thereof that include a number of electronic components for performing the functionality of instructions 522-526. Accordingly, processor 510 may be implemented across multiple processing units and instructions 522-526 may be implemented by different processing units in different areas of computer 500.

Machine-readable storage medium 520 may he any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 520 can be computer-readable and non-transitory. Machine-readable storage medium 520 may be encoded with a series of executable instructions for managing processing elements.

The instructions 522-526 when executed by processor 510 (e.g., via one processing element or multiple processing elements of the processor) can cause processor 510 to perform processes, for example, methods 100, 150, 200, and variations thereof. Furthermore, computer 500 may be similar to computing system 400 and may have similar functionality and be used in similar ways, as described above.

For example, extracting instructions 522 may cause processor 510 to extract lexical features, syntactic features, and semantic features from source code 532. Classifying instructions 524 may cause processor 510 to classify source code 532 by comparing the extracted lexical, syntactic, and semantic features to an expertise model. The expertise model may model a usage frequency of the lexical, syntactic, and semantic features according to a plurality of skill levels. Assigning instructions 526 may cause processor 510 to assign a risk estimate to the source code based on the classification.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method for evaluating source code, comprising:
extracting, using a processor, features from source code written in a programming language; and
classifying, using the processor, the source code by comparing the extracted features to an expertise model, the expertise model modeling a usage frequency of programming features of the programming language according to a plurality of skill levels.

2. The method of claim 1, wherein the expertise model further models other metrics relating to usage of the programming features.

3. The method of claim 1, further comprising assigning a skill level evaluation to an author of the source code based on the classification of the source code into one of the plurality of skill levels.

4. The method of claim , further comprising assigning a risk level to the source code based on the classification of the source code into one of the plurality of skill levels.

5. The method of claim 4, wherein the plurality of skill levels comprise at least a first skill level and a second skill level, the second skill level being associated with a lower risk level than the first skill level, the second skill level being represented in the model at least by a usage frequency histogram indicating a more frequent usage of a wider set of programming features than the first skill level.

6. The method of claim 1, wherein the programming features comprise at least one of lexical features of the programming language, syntactic features of the programming language, and semantic features of the programming language.

7. The method of claim 6, wherein the syntactic features of the programming language comprise statements, expressions, and structural elements.

8. The method of claim 6, wherein the semantic features of the programming language comprise relationships between the lexical features and syntactic features.

9. The method of claim 6, wherein extracting features from the source code comprises:
extracting lexical features of h source code based on a lexicon of the programming language;
extracting syntactic features of the source code using a parser; and
extracting semantic features of the source code based on the extracted syntactic features using a static program analysis tool.

10. The method of claim 1, further comprising:
performing the extracting and classifying steps on multiple modules of source code in a code base to estimate a level of expertise of authors of the modules; and
assigning a risk level to each of the modules based on the the estimated level of expertise of the author(s) of the module.

11. A system, comprising:
a model generator to generate an expertise estimation model based on labeled examples of source code written by multiple developers each associated with one of a plurality of skill levels, the expertise estimation model modeling a usage frequency of programming features; and
a classifier to classify source code into one of the plurality of skill levels using the expertise estimation model.

12. The system of claim 11, further comprising:
an extractor to extract features from a module of source code. wherein the classifier is configured to classify the module of source code by comparing the extracted features to the expertise estimation model.

13. The system of claim 12, further comprising:
a risk estimator to estimate a risk level of the module of source code based at least on the classified skill level and an additional software risk metric.

14. The system of claim 10, wherein the programming features comprise lexical features, syntactic features, and semantic features.

15. The system of claim 13, further comprising:
a parser to extract syntactic features from the source code; and
a static program analysis tool to extract semantic features from the source code.

16. A non-transitory computer readable storage medium storing instructions that, when executed by a processor, cause a computer to:
extract lexical features, syntactic features, and semantic features from source code; and
classify the source code by comparing the extracted lexical, syntactic, and semantic features to an expertise model, the expertise model modeling a usage frequency of the lexical, syntactic, and semantic features according to a plurality of skill levels.

17. The storage r medium of claim 1, further storing instructions that cause a computer to:
assign a risk estimate to the source code based on the classification.
